(19) United States
(12) Patent Application Publication
(10) Pub. No.: US 2012/0072228 A1
(43) Pub. Date: Mar. 22, 2012

(54) SELECTION OF SUPPLEMENTAL CONTENT FOR WIRELESS COMMUNICATION DEVICES BASED ON DEVICE STATUS

(75) Inventors: Bejoy Pankajakshan, Olathe, KS (US); Warren B. Cope, Olathe, KS (US)

(73) Assignee: Sprint Communications Company L.P., Overland Park, KS (US)

(21) Appl. No.: 12/886,277

(22) Filed: Sep. 20, 2010

(51) Int. Cl. G06F 15/16; G06Q 30/00

(52) U.S. Cl. 705/1.1; 709/217

(57) ABSTRACT

What is disclosed is a method of operating a wireless communication system. The method includes receiving a registration request from a wireless communication device, and in response, monitoring device status and updating a data structure with device status data for the wireless communication device. The method also includes processing the device status data to determine if a first device status condition is met by the device status data, and if the first device status condition is met by the device status data, selecting a supplemental content provider from a plurality of supplemental content providers based on the first device status condition. The method also includes receiving a content request from the wireless communication device for primary content from a primary content provider, and in response, determining an anonymous key associated with the wireless communication device and transferring the anonymous key for delivery to the selected supplemental content provider. The method also includes receiving supplemental content transferred by the selected supplemental content provider responsive to the transferred anonymous key, receiving the primary content transferred by the primary content provider, and transferring the primary content and the supplemental content to the wireless communication device.

### TECHNICAL FIELD

Aspects of the disclosure are related to the field of communications, and in particular, selecting supplemental content to wireless communication devices based on device status of wireless communication devices in wireless communication networks.

### TECHNICAL BACKGROUND

Wireless communication systems typically include wireless access systems, with equipment such as base stations, which provide wireless access to communication services for user devices over wireless links. A typical wireless communication system includes systems to provide wireless access across a geographic region, with wireless coverage areas associated with individual base stations. The wireless access systems exchange user communications and overhead communications between wireless communication devices and service providers for the communication services.

Communication services typically include voice calls, data exchange, web pages, streaming media, or text messages, among other communication services. As a part of these communication services, content from service providers can be handled through the wireless communication system for receipt by users of wireless communication devices. Many times, primary content, such as the data requested by a user, is accompanied by supplemental content, such as emergency notifications, advertising content, weather alerts, or network alerts, among other supplemental content.

### OVERVIEW

What is disclosed is a method of operating a wireless communication system. The method includes receiving a registration request from a wireless communication device, and in response, monitoring device status and updating a data structure with device status data for the wireless communication device. The method also includes processing the device status data to determine if a first device status condition is met by the device status data, and if the first device status condition is met by the device status data, selecting a supplemental content provider from a plurality of supplemental content providers based on the first device status condition. The method also includes receiving a content request from the wireless communication device for primary content from a primary content provider, and in response, determining an anonymous key associated with the wireless communication device and transferring the anonymous key for delivery to the selected supplemental content provider. The method also includes receiving supplemental content transferred by the selected supplemental content provider responsive to the transferred anonymous key, receiving the primary content transferred by the primary content provider, and transferring the primary content and the supplemental content to the wireless communication device.

What is also disclosed is a wireless communication system. The wireless communication system includes an access system configured to receive a registration request from a wireless communication device, and a control system configured to, in response the registration request, monitor device status and update a data structure with device status data for the wireless communication device. The control system is configured to process the device status data to determine if a first device status condition is met by the device status data, where if the first device status condition is met by the device status data, the control system is configured to select a supplemental content provider from a plurality of supplemental content providers based on the first device status condition. The access system is configured to receive a content request from the wireless communication device for primary content from a primary content provider. In response to the content request, the control system is configured to determine an anonymous key associated with the wireless communication device and transfer the anonymous key for delivery to the selected supplemental content provider. The access system is configured to receive supplemental content transferred by the selected supplemental content provider responsive to the transferred anonymous key, receive the primary content transferred by the primary content provider, and transfer the primary content and the supplemental content to the wireless communication device.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a communication system.

FIG. 2 is a flow diagram illustrating a method of operation of a wireless communication system.

FIG. 3 is a system diagram illustrating a communication system.

FIG. 4 is a sequence diagram illustrating a method of operation of a communication system.

FIG. 5 is a block diagram illustrating a control system.

### DETAILED DESCRIPTION

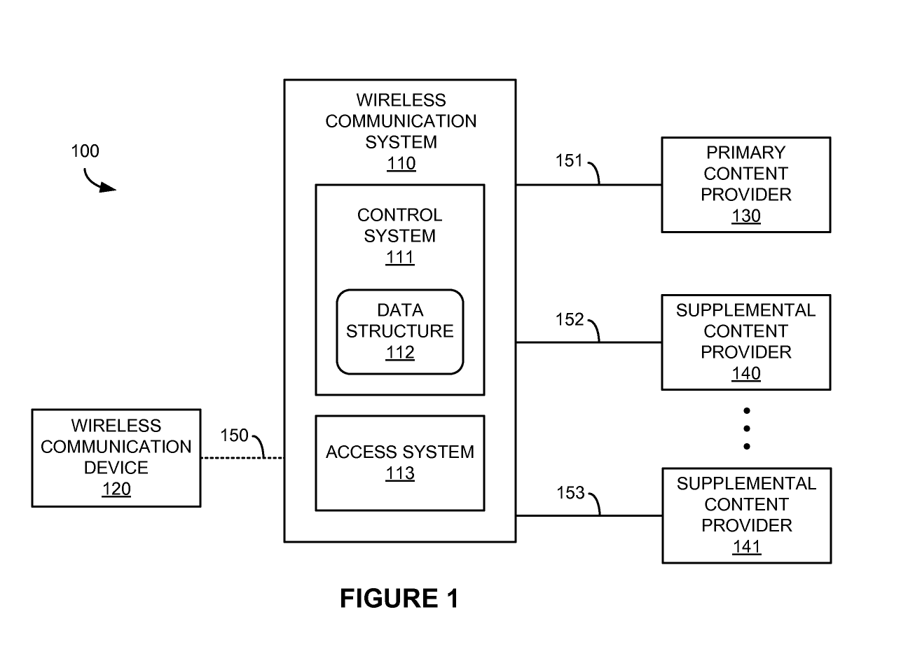

FIG. 1 is a system diagram illustrating communication system 100. Communication system 100 includes wireless communication system 110, wireless communication device 120, primary content provider 130, and supplemental content providers 140-141. Wireless communication system 110 and wireless communication device 120 communicate over wireless link 150. Wireless communication system 110 and primary content provider 130 communicate over link 151. Wireless communication system 110 and supplemental content providers 140-141 communicate over links 152-153, respectively. In FIG. 1, wireless communication system 110 includes control system 111 and access system 113, which are communicatively coupled to each other in this example. Control system 111 includes data structure 112 in this example.

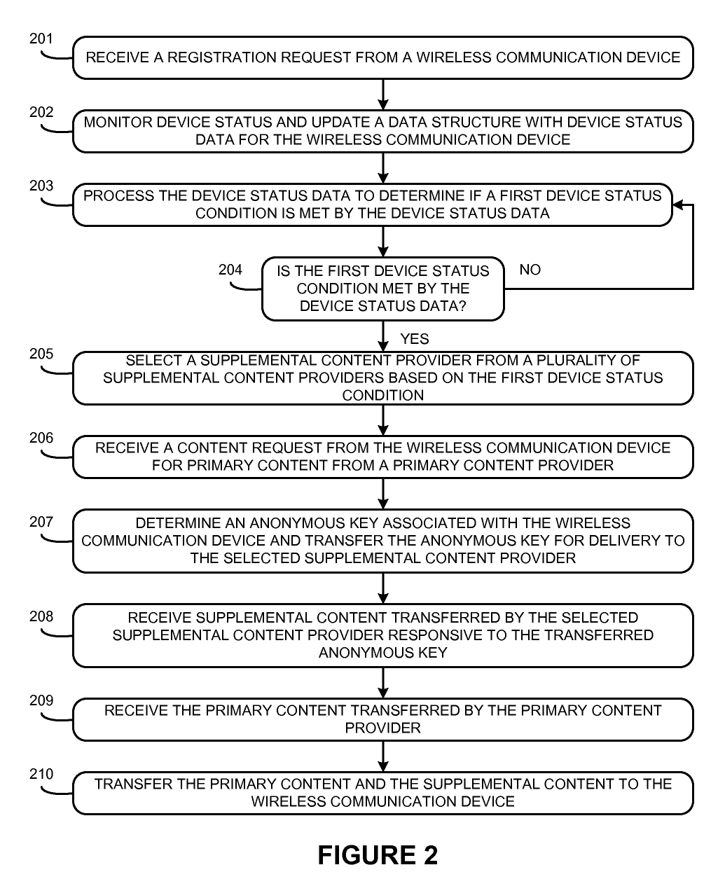

FIG. 2 is a flow diagram illustrating a method of operation of wireless communication system 110. The operations of FIG. 2 are referenced herein parenthetically. In FIG. 2, wireless communication system 110 receives (201) a registration request from wireless communication device 120. The registration request could include an initial request for a communication session with wireless communication system 110, handoff messaging for transferring service from a coverage area of wireless communication system 110 to another coverage area of wireless communication system 110, an initial registration of wireless communication device 120 with wireless communication system 110 after a device power-on, or other registration requests. In this example, access system 113 includes equipment and systems to provide wireless access to communication services for wireless communication devices, such as wireless communication device 120 over wireless link 150. Wireless communication device 120 could communicate with systems or equipment of access system 113 to transfer the registration request information as discussed above.

In response to the registration request, wireless communication system 110 monitors (202) device status and updates a data structure with device status data for wireless communication device 120. In this example, control system 111 monitors the device status in response to access system 113 receiving a registration request from wireless communication device 120. Control system 111 updates data structure 112 with the device status data for wireless communication device 120, although in other examples, access system 113 or data structure 112 could include equipment and systems to monitor the device status and update data structure 112 with the device status data. In this example, the device status is associated with a present location of wireless communication device 120, and the device status data includes a representation of the present location. As wireless communication device 120 moves, the present location is monitored by wireless communication system 110 and the device status data is updated in data structure 112. In other examples, wireless communication device 120 determines and transfers a present location for delivery to wireless communication system 110. The device status data could include a time in a wireless coverage area, an identifier of a wireless access node associated with wireless communication device 120, a sector location of wireless communication device 120, a velocity of wireless communication device 120, a device type of wireless communication device 120, a present RF signal quality associated with wireless communication device 120, or information associated with wireless link 150, including combinations thereof.

Wireless communication system 110 processes (203) the device status data to determine if a first device status condition is met by the device status data. Device status conditions include conditional thresholds associated with particular device status data information. For example, location-based information could be indicated in the device status data for wireless communication devices, and a location-based condition could be established for the device status data, such as a location-based data threshold. When the location-based device status data satisfies the location-based condition, then device status data has met the device status condition. Other device status conditions could be employed, such as time-based conditions, signal quality thresholds, wireless communication device type conditions, or user history conditions, among other conditions and thresholds. In some examples, the device status data is periodically or continually processed to determine if a device status condition is satisfied. In other examples, the device status data is processed in response to a content request received by wireless communication system 110 from wireless communication device 120 to determine if a device status condition is satisfied, such as the content request discussed in operation 206 below.

If the first device status condition is not met by the device status data (204), then wireless communication system 110 continues to process the device status data to determine if the first device status condition is met by the device status data. However, if the first device status condition is met by the device status data (204), then wireless communication system 110 selects (205) a supplemental content provider from a plurality of supplemental content providers based on the first device status condition. In the example shown in FIG. 1, two supplemental content providers 140-141 are shown, although a different number of supplemental content providers could be included, and supplemental content provider 140 is selected by wireless communication system 110. In some examples, wireless communication system 110 determines associations between a plurality of device status conditions and the plurality of supplemental content providers 140-141, where the first device status condition comprises a first one of the plurality of device status conditions determined to be associated with the selected supplemental content provider. Wireless communication system 110 could also process ones of the plurality of device status conditions which are preselected by ones of the plurality of supplemental content providers to determine the associations between the plurality of device status conditions and the plurality of supplemental content providers based on the pre-selections.

Wireless communication system 110 receives (206) a content request from wireless communication device 120 for primary content from a primary content provider. The content request could include a request by wireless communication device 120 for user content from a content provider, such as a data request, voice call, voice over Internet protocol (VoIP) call, web page, video stream, audio stream, or other content or communication session request. Access system 113 could receive the content request, and transfer the content request to control system 111 in some examples. In further examples, wireless communication system 110 transfers the content request for delivery to primary content provider 130 over link 151. Primary content provider 130 receives the content request transferred over link 151 in this example, however, it should be understood that link 151 could include intermediary links, such as the Internet, or other networks, links, or systems. The content request could include a content request unrelated to the request from wireless communication device 120 in operation 201. For example, a voice call or handoff could initiate the registration request, while a data session could initiate a content request unrelated to the voice call, although from the same wireless communication device.

In response to the content request, wireless communication system 110 determines (207) an anonymous key associated with wireless communication device 120 and transfers the anonymous key for delivery to the selected supplemental content provider. As discussed above, the selected supplemental content provider in this example is supplemental content provider 140. The anonymous key is determined to be associated with wireless communication device 120, while maintaining anonymity of wireless communication device 120 or a user of wireless communication device 120. The anonymous key could be determined by hashing, encrypting, obfuscating, randomizing, or otherwise rendering anonymous or quasi-anonymous an identifier associated with wireless communication device 120, including combinations thereof. In other examples, the anonymous key could be generated by wireless communication system 110 and subsequently assigned as an anonymous key associated with wireless communication device 120. Selected supplemental content provider 140 receives the anonymous key transferred over link 152 in this example, however, it should be understood that link 152 could include intermediary links, such as the Internet, or other networks, links, or systems. This anonymous key allows supplemental content provider 140 to associate content for wireless communication device 120 without obtaining an identity of wireless communication device 120. An identity of wireless communication device 120 or user of wireless communication device 120 could include a phone number, network access identifier (NAI), electronic serial number (ESN), mobile equipment identifier (MEID), personal name, or billing address, among other information identifying a person or actual physical device.

Wireless communication system 110 receives (208) supplemental content transferred by selected supplemental content provider 140 responsive to the transferred anonymous key. The supplemental content, as transferred for delivery to wireless communication system 110 by selected supplemental content provider 140, is received over link 152, although other configurations could be employed. The supplemental content could include emergency notifications, advertising content, weather alerts, or network alerts, among other supplemental content. In some examples, the supplemental content is of a similar format or data type as the primary content requested from primary content provider, such as web pages, streaming content, audio information, video content, among other content types. In typical examples, the supplemental content is selected by selected supplemental content provider 140 responsive to receiving an anonymous key, triggered by a particular device status condition being met by the device status data, such as location-based supplemental content, time-based supplemental content, device-type based supplemental content, or supplemental content related to both a present time and location of wireless communication device 120, among other selections associated with the particular device status condition being met.

Wireless communication system 110 receives (209) the primary content transferred by primary content provider 130. In this example, the primary content is received over link 151, although other configurations could be employed. The primary content includes the content requested by wireless communication device 120 or a user of wireless communication device 120 as described in operation 206. It should be understood that the primary content could be received at a varying time with respect to the supplemental content.

Wireless communication system 110 transfers (210) the primary content and the supplemental content to wireless communication device 120. In this example, the primary content and the supplemental content are transferred over wireless link 150. The primary content includes content responsive to the primary content request, while the supplemental content includes content responsive to the device status data meeting the device status condition. Wireless communication system 110 could combine the primary content with the supplemental content for transfer to wireless communication device 120. For example, if a web page was requested in the primary content request, the supplemental content could include advertising content and wireless communication system 110 could transfer the requested web page along with advertising content to wireless communication device 120 responsive to the primary content request. In further examples, the supplemental content is integrated into streaming content, such as streaming video content, animations, or streaming audio content for playback on wireless communication device 120. In yet further examples, the supplemental content can supercede or interrupt the primary content, such as when the supplemental content includes weather or emergency alerts.

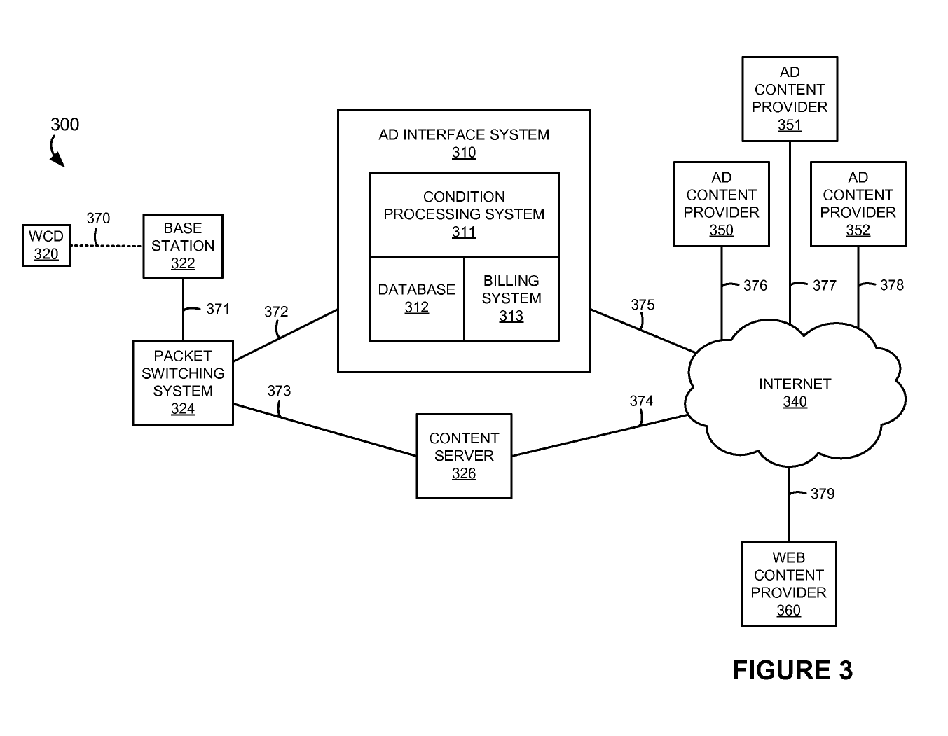

FIG. 3 is a system diagram illustrating communication system 300. Communication system 300 includes ad interface system 310, wireless communication device (WCD) 320, base station 322, packet switching system 324, content server 326, Internet 340, advertisement (ad) content providers 350-352, and web content provider 360. Wireless communication device 320 and base station 322 communicate over wireless link 370. In this example, wireless access is provided by base station 322 to wireless communication device 320 using the Evolution Data Optimized (EV-DO) wireless protocol over wireless link 370, although other wireless communication protocols could be employed. Packet switching system 324 communicates with base station 322 over link 371, an Ethernet link capable of carrying Internet protocol (IP) packets. Ad interface system 310 and packet switching system 324 communicate over link 372, a local-area Ethernet network link. Content server 326 and packet switching system 324 communicate over link 373, a local-area Ethernet network link. Content server 326 and ad content providers 350-352 communicate over IP link 374, Internet 340, and the respective IP links 376-378. Content server 326 and web content provider 360 communicate over IP link 374, Internet 340, and IP link 379. Ad interface system 310 and ad content providers 350-352 communicate over IP link 375, Internet 340, and the respective IP links 376-378 in this example.

Ad interface system 310 includes condition processing system 311, database 312, and billing system 313. Condition processing system 311, database 312, and billing system 313 each include computer systems comprising processing equipment and computer-readable storage media, and each could be included in the same equipment and systems. In this example, condition processing system 311 is configured to receive and monitor device status data from packet switching system 324, store device status data in database 312, process device status conditions, determine anonymous keys, select ad content providers, and indicate selection information to billing system 313, among other operations. Packet switching system 324 includes equipment and systems for routing data communications between base station 322 serving wireless communication devices and other systems, such as Internet 340 and content server 326. Packet switching system 324 also includes equipment for determining and transferring device status data to ad interface system 310. Although packet switching system 324 is shown as a packet switching system in this example, packet switching system 324 could comprise packet data switching nodes (PSDN), mobile switching centers (MSC), General Packet Radio Service (GPRS) support nodes, home agents, or include equipment such as base station controllers, packet routers, bridges, gateways, or other equipment and systems. Content server 326 includes computer systems, routers, processing equipment, and computer-readable storage media, to transfer primary and supplemental content received from ad content provider 350 and web content provider 360 to wireless communication devices. Although content server 326 is shown as a separate module in FIG. 3, it should be understood that content server 326 could be included in ad interface system 310 or packet switching system 324 in other examples. Communication system 300 could also comprise a radio access network (RAN), wireless access system, or further base stations, control systems, servers, and databases to provide wireless access to communication services for wireless communication devices over a geographic area.

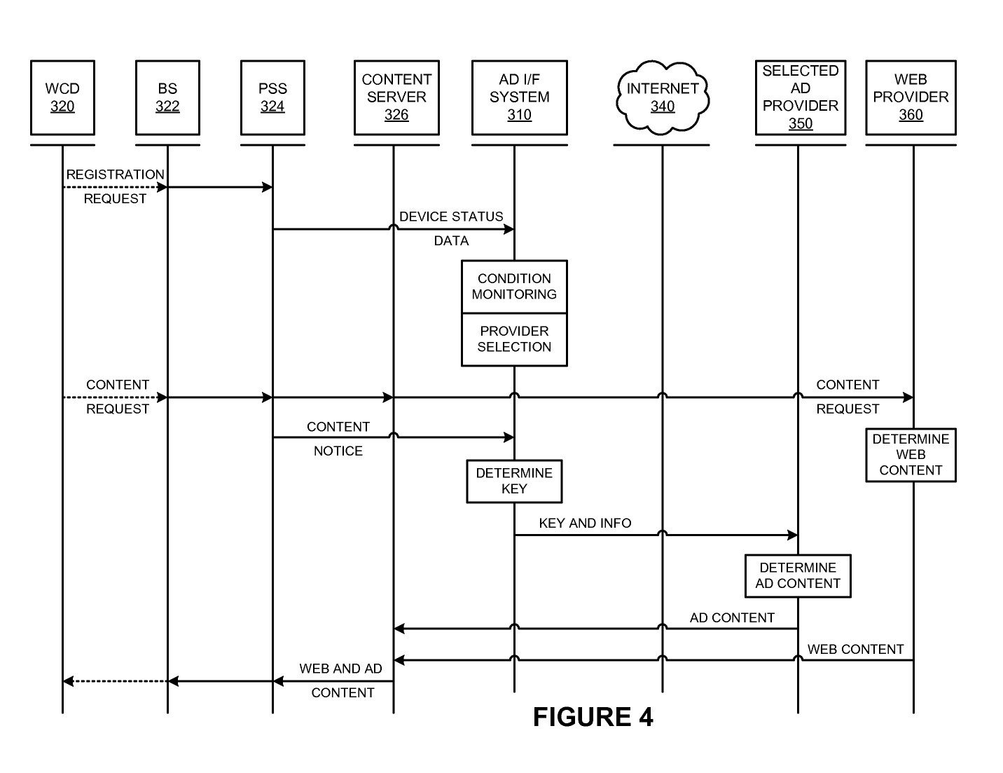

FIG. 4 is a sequence diagram illustrating a method of operation of communication system 300. In FIG. 4, wireless communication device (WCD) 320 transfers a registration request to base station (BS) 322. In this example, the registration request is transferred by wireless communication device 320 over wireless link 370 in order to request wireless access through base station 322, such as due to a device power-on or handoff from another base station. In other examples, the registration request includes a request to initiate a communication session with base station 322, such as a voice call, data session, email transfer, text message, video stream, audio stream, or other communication session. Base station 322 transfers this registration request to packet switching system (PSS) 324. Responsive to the registration request, base station 322 and packet switching system 324 can coordinate with wireless communication device 320 to establish a communication session over wireless link 370, such as completing a registration or authentication process, assigning communication channels, frequencies, timeslots, or spreading codes for a communication session.

Also responsive to the registration request, packet switching system 324 determines device status for wireless communication device 320 and transfers device status data related to the device status to ad interface system 310 for storage in database 312. Although FIG. 4 shows the device status data being transferred to ad interface system 310 during one instance, it should be understood that packet switching system 324 could continue to determine the device status of wireless communication device 320 and transfer associated device status data to ad interface system 310. Ad interface system 310 then stores the device status data in database 312 for later retrieval on a computer-readable storage medium, such as a hard drive, server, solid-state storage device, random-access memory, or memory cache, among other equipment. The device status data for wireless communication device 320 could be stored in database 312 according to an identifier associated with wireless communication device 320. In some examples, the identifier associated with wireless communication device 320 in database 312 reveals an identity of wireless communication device, such as a user name, phone number, network access identifier (NAI), electronic serial number (ESN), mobile equipment identifier (MEID), or other identifier associated with a person or physical device. In other examples, a pseudorandom identifier or an anonymous identifier is generated and used to associate the device status data with wireless communication device 320 in database 312 to protect an identity of a user or physical device while the device status data is stored in database 312. In further examples, the pseudorandom identifier or anonymous identifier could accompany the device status data from packet switching system 324, so that no revealing identity of a user or physical device of wireless communication device 320 is received by ad interface system 310.

The device status data could include information as discussed in FIG. 2 herein, among other information. For example, the device status data could be associated with a present location of wireless communication device 320, and include a digital representation of the present location. A present location of wireless communication device 320 could include a present sector, present wireless coverage area, serving base station, geographic coordinates, velocity, speed, or other location information. The present location, among other device status data, could be determined by wireless communication device 320 and transferred for delivery to condition processing system 311, or could be determined by base station 322 or packet switching system 324 for delivery to condition processing system 311. In other examples, the device status data could include a present time, a time in a present wireless coverage area, a time of entry into a present wireless coverage area, a velocity of wireless communication device 320, a device type of wireless communication device 320, a present RF signal quality associated with wireless communication device 320, or information associated with wireless link 370, including combinations thereof.

Condition processing system 311 of ad interface system 310 processes the device status data provided by packet switching system 324 to determine if any device status conditions are met by the device status data. Device status conditions include conditional thresholds associated with particular device status data or information. For example, time-based information could be indicated in the device status data for wireless communication devices, and a time-based condition could be established for the device status data, such as a time threshold of a wireless communication device present in a sector of wireless coverage. When the time-based device status data satisfies the time-based condition, then device status data has met the device status condition. Other device status conditions could be employed, such as location-based conditions, signal quality thresholds, wireless communication device type conditions, or user history conditions, among other conditions and thresholds. Multiple device status conditions could be monitored along with the device status data for multiple wireless communication devices. Once a device status condition is met for a particular wireless communication device, an indicator of the met condition and the wireless communication device could be stored in condition processing system 311, database 312, or billing system 313.

If a device status condition is met by the device status data, then condition processing system 311 selects an ad provider from among ad providers 350-352 based on which device status condition is met. In this example, ad provider 350 is selected. Also, in the example shown in FIG. 3, three ad providers, 350-352 are shown, although a different number of ad providers could be included, along with other supplemental content providers. The device status data could be periodically or continually processed by condition processing system 311 to determine if a device status condition is satisfied. In other examples, the device status data is processed in response to a content notice received by ad interface system 310, which triggers condition processing system 311 to determine if any device status conditions are satisfied.

An ad provider is selected based on the particular device status condition being met by the device status data. For example, if a first time-based condition is met by the device status data, then a first ad provider is selected, whereas if a second time-based condition is met by the device status data, then a second ad provider is selected. In another example, if a first location-based condition is met by the device status data, then a first ad provider is selected, whereas if a second location-based condition is met, then a second ad provider is selected. The selection could also be based on the ad type or ad information provided by each of ad provider 350-352. In other examples, the selection could also be based on which device status conditions are preselected by ad providers 350-352, such as by ones of ad providers 350-352 purchasing a satisfied device status condition as a trigger for an ad provider selection. In further examples, ad providers 350-352 each provide unique ad content, such as ad provider 350 providing pizza restaurant ad content, ad provider 351 providing telecommunications ad content, and ad provider 352 providing concert ad content. The unique ad content could be correlated among different device status conditions, and condition processing system 311 selects between the different ad providers based on the particular device status condition being met. In yet further examples, a first ad provider could be selected when the device status data indicates that wireless communication device 320 first enters into a particular sector of wireless coverage, and a second ad provider could be selected when the device status data indicates that the wireless communication device has remained in the sector of wireless coverage for a period of time. As discussed further herein, the different selections of ad providers based on the device status conditions could be correlated to a fee or monetary cost to be paid by the selected ad provider.

In many examples, multiple device status conditions are employed across ad providers 350-352. Condition processing system 311 could determine associations between each of the multiple device status conditions and each of ad providers 350-352, where a first device status condition comprises a first one of the device status conditions determined to be associated with a selected ad provider. Condition processing system 311 could process ones of the device status conditions purchased or preselected by ones of ad providers 350-352 to determine the associations between the device status conditions and ad providers 350-352.

Historical data could also be processed to select an ad provider from among ad providers 350-352. This historical data could be stored in database 312 and associated with wireless communication device 320 or users of wireless communication device 320, and could include past satisfied device status conditions, past device status data, or information on past usage of communication services, such as past text message, email, data, or voice calling activity. The historical data could also indicate users with a heavy usage or high bill amounts, or users who exchange data or place voice calls with certain destinations, such as international calls to a particular country. Particular ad providers could be selected based on device status conditions being met for this historical data, or in combination with present device status data.

Base station 322 receives a content request from wireless communication device 320, and transfers the content request to packet switching system 324. Packet switching system 324 transfers the content request to content server 326. In other examples, base station 322 transfers the content request to content server 326. In response to the content request, packet switching system 324 transfers a content notice to ad interface system 310. The content notice indicates a content request is pending and could include information found in the content request, information about wireless communication device 320, or comprise the content request. The content request could be related or unrelated to the registration request transferred by wireless communication device 320. In this example, the content request includes a website address, such as an IP address, of a desired web page. In other examples, the content request could include a network address, streaming media channel identifier, telephone number, user identifier, user credentials, among other content or user identifiers. The content request indicates wireless communication device 320 desires content from a primary content provider, such as web content provider (web provider) 360 in this example. Content server 326 transfers the content request for delivery to web provider 360, over Internet 340, although other systems may be involved in transferring the content request. In response to the content request, web provider 360 determines web content for delivery to wireless communication device 320, and transfers the web content. Although FIG. 4 shows the web content being transferred shortly after the web content is determined by web provider 360, it should be understood that the web content could be transferred at other times, as in examples when the web content requires additional time to be determined and transferred.

Ad interface system 310 determines an anonymous key to be associated with wireless communication device 320. In this example, the anonymous key is determined by applying a hashing process to the electronic serial number (ESN) of wireless communication device 320. The hashing process determines an identifier unrelated to the ESN to represent the ESN in an anonymous manner, such as generating a random or pseudo-random number based upon the ESN or other data, and then associating the hashed ESN with wireless communication device 320. The anonymous key allows wireless communication device 320 to be identified in an anonymous manner without revealing an actual identity of wireless communication device 320 or a user of wireless communication device 320. This anonymous key could be determined in response to the content notice, while in other examples, the key is predetermined and assigned to wireless communication device 320 upon receipt of the content notice.

Once the key has been determined, ad interface system 310 transfers the key for delivery to the selected ad content provider, along with information about which device status condition was met by the device status data. In this example, the selected ad content provider is ad content provider (ad provider) 350. Thus, ad interface system 310 transfers the key and the device status condition information for delivery to selected ad provider 350 over links 375 and 376 through Internet 340. Selected ad provider 350 receives the key transferred by ad interface system 310, over Internet 340, in this example.

Selected ad provider 350 then determines ad content based on the transferred key, which is associated with the device status condition being met for wireless communication device 320. The ad content could include fixed or predetermined ad content, such as when ad provider 350 is for a food company, and provides ad content for the food product associated with ad provider 350. The ad content could also be determined based on the particular device status condition being met by the device status data. As discussed herein, the device status data could indicate a present location, a time in a present location, a device type, brand, or model, or other information for wireless communication device 320. In some examples, a device type, model, or brand could be used to determine the ad content, such as determining a first ad content for users of a first model of wireless communication device, and a different ad content for users of other models of wireless communication devices. Time-based information in the device status data could also be used to determine the ad content. In examples of time-based information, the device status conditions could be triggered on based on the time that a wireless communication device is present in a sector of wireless coverage. Thus, ad content based on the time in a sector could be determined by selection of an ad provider associated with the time-based device status condition. A first ad provider, such as ad provider 350, could determine a first ad content for a wireless communication device which has recently entered into a new sector of wireless coverage, as indicated by the device status condition met which triggers selection of ad provider 350 by condition processing system 311. A second ad provider, such as ad provider 351, could determine a second ad content for a wireless communication device which has lingered in a sector of wireless coverage for a period of time greater than the recent wireless communication device, as indicated by the device status condition met which triggers selection of ad provider 351 by condition processing system 311. Different ad content could also be delivered to a single wireless communication device at different times while present in a single sector of wireless coverage, such as a first ad content when the wireless communication device makes a content request when newly entering the sector, and a second ad content when the wireless communication device makes a content request after remaining in the sector for a predetermined time, as determined by condition processing system 311 selecting different ad content providers based on the triggered device status conditions. It should be understood that a single ad provider could be associated with multiple device status conditions, and different ad information selected based on the particular device status condition being met. In examples where a single ad provider is associated with multiple device status conditions, ad interface system 310 could include information about which device status condition was met by the device status data with the anonymous key, or in a separate transfer for delivery to the selected ad provider. Other ad content determinations based on the device status conditions could be provided, including combinations thereof. It should be understood that although ad content is discussed in this example, the ad providers could also transfer non-advertisement supplemental content as discussed herein.

A selected ad provider could pay different prices for ad content served to wireless communication devices based on the device status condition met, such as paying more for ads served to new wireless communication devices in a sector of wireless coverage, and paying less for ads served to wireless communication devices which linger in a sector of wireless coverage. Other examples of ad cost differentials could be determined, such as based on device model, past device status data, or other considerations. In further examples of the device status condition examples discussed herein, a first ad provider selected may pay a higher fee to get selected upon initial entry of a wireless communication device into a sector, and a second ad provider may pay a lower fee to get selected after a wireless communication device lingers in a sector. Billing system 313 could associate a monetary cost with condition processing system 311 selecting the selected ad provider from the plurality of ad providers 350-352 based on the satisfied device status condition, and transfer an indicator of the monetary cost for delivery to the selected ad provider. Billing system 313 would receive information on the ad providers selected, the conditions met, among other information, from condition processing system 311. Billing system 313 could process the information and determine fees and billing rates for each of ad providers 350-352, and transfer an electronic invoice or other billing information to each of ad providers 350-352 over Internet 340 for payment.

Once the ad content is determined by selected ad provider 350, the ad content is transferred by selected ad provider 350 for delivery to content server 326. The ad content is transferred over Internet 340 in this example. The key could accompany the ad content to associate the ad content with wireless communication device 320, or other identifiers could be used to associate the ad content with the device status data, such as a transaction identifier or network identifier. Ad interface system 310 could also transfer the key to content server 326, among other information, to assist content server 326 in correlating the ad content received to a particular transaction or content request.

After receiving both the supplemental content, namely the ad content in this example, and the primary content, namely the web content, content server 326 transfers the ad content and web content for delivery to wireless communication device 320 through base station 322. In this example, the primary content includes content responsive to the primary content request, while the supplemental content includes content responsive to the device status data. In some examples, the ad content and web content are merged into the content type of the primary content, such as when a banner advertisement from selected ad provider 350 accompanies a web page from web provider 360. In other examples, a separate ad content type than the primary content type is provided, such as when a streaming video content is received from web content provider 360 and a static overlay ad is provided by selected ad provider 350. A type or format of the primary content, as originally requested in the content request, could also be provided to selected ad provider 350 by ad interface system 310 or content server 326 to allow selected ad provider 350 to select an ad format based upon the primary content type. It should be understood that the ad content and the web content could be transferred at different times by content server 326 for delivery to wireless communication device 320. Web browser, rendering software, or media player applications of wireless communication device 320 could then merge the primary content with the supplemental content after receiving the web content and ad content from base station 322.

In further examples, the device status data could be provided along with the anonymous key to selected ad provider 350. As discussed above, the device status data could include location, timing, device-type, or other status information for wireless communication device 320. In examples where the device status data is provided to an ad provider, the device status data is configured to not reveal an actual identity of wireless communication device 320, such as an identity of a user or actual physical device, and thus the identity of wireless communication device 320 is kept relatively anonymous from the ad provider. However, the device status data would reveal information about wireless communication device 320, such as location, timing, or usage activity, which allows an ad provider to make intelligent ad content choices based on the device status data.

Additionally, the key transferred by ad interface system 310 for delivery to selected ad provider 350 could be associated with wireless communication device 320 for only a present content request, such as a dynamic key which is re-determined for each content request. In other examples, the key transferred by wireless communication device 320 could be associated with wireless communication device 320 for a longer duration than the dynamic key, such as a static key for multiple content requests. In examples where a static key is employed, ad interface system 310 or selected ad provider 350 could retain long-term device status data for wireless communication device 320, and selected ad provider 350 could determine ad content in response to the present instance of the key transfer as well as upon past instances of key transfers for the same key. For example, long term ad content information could determined for keys associated with wireless communication devices having past visits within a particular wireless coverage area.

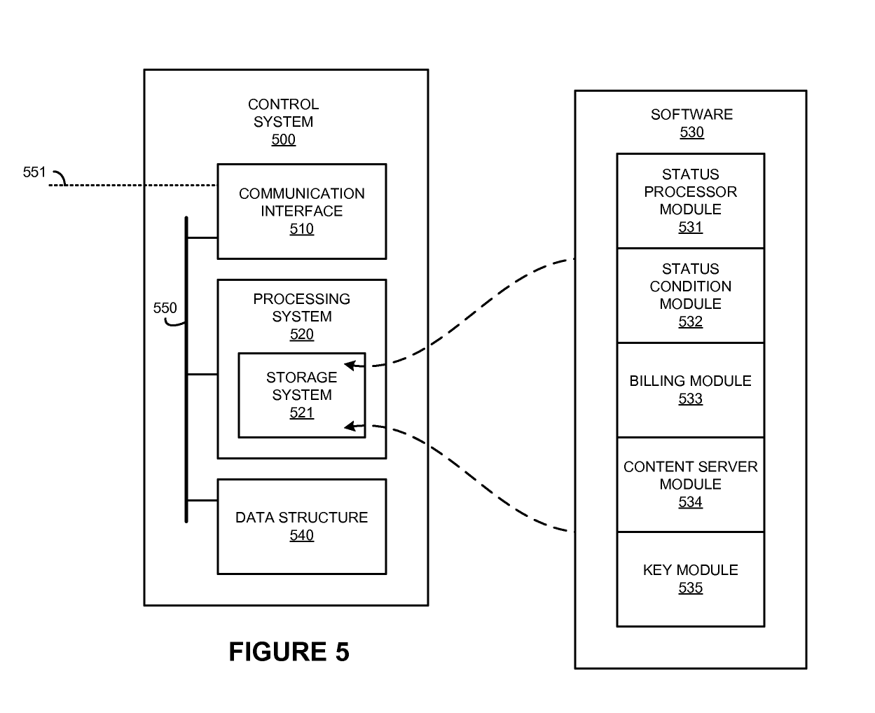

FIG. 5 is a block diagram illustrating control system 500, as an example of control system 111 found in FIG. 1 or ad interface system 310 found in FIG. 3, although control system 111 or ad interface system 310 could use other configurations. Control system 500 includes communication interface 510, processing system 520, and data structure 540. Communication interface 510, processing system 520, and data structure 540 communicate over bus 550. Control system 500 may be distributed among multiple devices that together form elements 510, 520-521, 530, 540, and 550-551.

Communications interface 510 comprises communication equipment for communicating over link 551, such as receiving content notices, device status information, or device status requests, and transferring device status data, device status condition information, and associated keys. Communication interface 510 also receives command and control information and instructions from processing system 520 over bus 550. Link 551 could use various protocols or communication formats as described herein for links 151-153 or 371-379, including combinations, variations, or improvements thereof.

Processing system 520 includes storage system 521. Processing system 520 retrieves and executes software 530 from storage system 521. In some examples, processing system 520 is located within the same equipment in which communication interface 510 or data structure 540 are located. In further examples, processing system 520 comprises specialized circuitry, and software 530 or storage system 521 could be included in the specialized circuitry to operate processing system 520 as described herein. Storage system 521 could include a computer-readable medium such as a disk, tape, integrated circuit, server, or some other memory device, and also may be distributed among multiple memory devices.

Software 530 may include an operating system, logs, utilities, drivers, networking software, and other software typically loaded onto a computer system. Software 530 could contain application programs, firmware, or some other form of computer-readable processing instructions. When executed by processing system 520, software 530 directs processing system 520 to operate as described herein, such as process device status requests and content notices, store and retrieve device status data with data structure 540, monitor device status conditions, determine keys associated with device status data, or determine billing information, among other operations.

In this example, software 530 includes status processor module 531, status condition module 532, billing module 533, content server module 534, and key module 535. It should be understood that a different configuration could be employed, and individual modules of software 530 could be included in different equipment than control system 500. Status processor module 531 receives device status data which has been received by communication interface 510 over link 551. Status processor module 531 stores the device status data in data structure 540 and monitors the device status data for events according to device status conditions of status condition module 532. Status condition module 532 includes device status conditions, such as trigger events, trigger algorithms, status thresholds, among other conditions, which are monitored by status processor module 531 along with received device status data to determine when device status conditions are met by device status data. Billing module 533 receives information on met status conditions and selected supplemental content providers to determine monetary costs or pricing involved with the met status conditions or selection of a supplemental content provider. This cost or pricing information can be accumulated in storage system 521 or data structure 540 for later transfer to a supplemental content provider, such as issuing an invoice, or transactional cost notifications, among other information. Content server module 534 receives primary and supplemental content from content providers and transfers the content for delivery to user devices. In some examples, the supplemental content is accompanied by anonymous keys associated with user devices, and content server module 534 correlates the supplemental content to a particular user device or content request using the received anonymous keys. Key module 535 generates and transfers anonymous keys for delivery to supplemental content providers. The keys are generated in response to content requests or content notices received by communication interface 510. Key module 535 and content server module 534 could exchange anonymous key information to correlate supplemental content with user devices or content requests.

Data structure 540 comprises a computer-readable medium such as a disk, tape, integrated circuit, server, or some other memory device, and also may be distributed among multiple memory devices. Data structure 540 may include a database, operating system, logs, utilities, drivers, networking software, and other software typically loaded onto a computer system. Data structure 540 could contain application programs, firmware, or some other form of computer-readable processing instructions. Data structure 540 stores and retrieves device status data associated with wireless communication devices or keys.

Bus 550 comprises a physical, logical, or virtual communication link, capable of communicating data, control signals, and communications, along with other information. In some examples, bus 550 is encapsulated within the elements of communication interface 510, processing system 520, or data structure 540, and may be a software or logical link. In other examples, bus 550 uses various communication media, such as air, space, metal, optical fiber, or some other signal propagation path, including combinations thereof. Bus 550 could be a direct link or might include various equipment, intermediate components, systems, and networks.

Referring back to FIG. 1, wireless communication system 110 includes control system 111, data structure 112, and access system 113. Wireless communication system 110 may also further comprise data modems, routers, servers, memory devices, software, databases, processing systems, cabling, network communication interfaces, physical structural supports, or other communication apparatuses.

Control system 111 comprises data structure 112 as well as systems and equipment for determine device status data associated with device status, storing device status data in a data structure, monitoring device status conditions, selecting supplemental content providers based on device status conditions, determining keys associated with user devices responsive to content request from the user devices, transferring anonymous keys for delivery to supplemental content providers responsive to device status data requests, among other operations. Control system 111 also includes communication interfaces, as well as computer systems, microprocessors, circuitry, or some other processing devices or software systems, and may be distributed among multiple processing devices. Examples of control system 111 may also include software such as an operating system, logs, databases, utilities, drivers, networking software, and other software stored on a computer-readable medium. Control system 111 could also include application servers, application service provider systems, database systems, web servers, streaming media servers, authentication systems, or other systems.

In some examples, data structure 112 comprises a computer-readable medium for storing device status data for wireless communication device 120. Data structure 112 could be included in the equipment or systems of control system 111 or access system 113, or be included in separate equipment or systems. In examples of separate equipment or systems, data structure 112 could include communication interfaces, computer systems, microprocessors, circuitry, or other processing devices or software systems, and may be distributed among multiple processing devices. Examples of data structure 112 may also include software such as an operating system, logs, databases, utilities, drivers, networking software, and other software stored on a computer-readable medium. Data structure 112 could also include location systems, application servers, application service provider systems, database systems, web servers, cloud-based storage systems, or other systems.

Access system 113 comprises RF communication and control circuitry, antenna elements, and communication routing equipment and systems. The RF communication circuitry typically includes amplifiers, filters, RF modulators, transceivers, and signal processing circuitry. In many examples, wireless communication system 110 includes equipment to provide wireless access to communication services within different coverage areas to user devices such as wireless communication device 120 shown in FIG. 1, route communications between content providers and wireless communication devices, receive registration and content requests, monitor device status for user devices, determine device status data associated with the device status, communicate with control system 111 and data structure 112, or provide network information, handoff information, or configuration information to wireless communication devices, among other operations. Access system 113 may also comprise base stations, base transceiver stations (BTS), base station controllers (BSC), mobile switching centers (MSC), radio node controllers (RNC), call processing systems, authentication, authorization and accounting (AAA) equipment, access service network gateways (ASN-GW), packet data switching nodes (PDSN), home agents (HA), General Packet Radio Service (GPRS) support nodes, Internet access nodes, telephony service nodes, wireless data access points, or other wireless communication equipment.

Wireless communication device 120 comprises radio frequency (RF) communication circuitry and antenna elements. The RF communication circuitry typically includes amplifiers, filters, modulators, and signal processing circuitry. In many examples, wireless communication device 120 includes circuitry and equipment to exchange communications of wireless communication services over wireless links with wireless access systems, transfer registration requests for wireless access, transfer content requests for communication services, and receive primary and supplemental content from a wireless communication system, among other operations. Wireless communication device 120 may also include user interface systems, memory devices, computer-readable storage mediums, software, processing circuitry, or other communication components. Wireless communication device 120 may be a user device, subscriber equipment, customer equipment, access terminal, telephone, mobile wireless telephone, computer, e-book, mobile Internet appliance, wireless network interface card, media player, game console, or some other wireless communication apparatus, including combinations thereof. Although one wireless communication device is shown in FIG. 1, it should be understood that a different number of wireless communication devices could be shown.

Primary content provider 130 comprises systems and equipment for receiving content requests transferred by user devices, such as wireless communication devices, and providing primary content responsive to the content requests for delivery to user devices, among other operations. Primary content provider 130 also includes communication interfaces, as well as computer systems, microprocessors, circuitry, or some other processing devices or software systems, and may be distributed among multiple processing devices. Examples of primary content provider 130 may also include software such as an operating system, logs, databases, utilities, drivers, networking software, and other software stored on a computer-readable medium. Primary content provider 130 could also include application servers, application service provider systems, cloud-based systems, database systems, web servers, streaming media servers, authentication systems, or other systems.

Supplemental content providers 140-141 each comprise systems and equipment for receiving keys associated with user devices from wireless communication systems or ad interface systems, and transferring supplemental content in response to receiving anonymous keys for delivery to user devices, among other operations. Supplemental content providers 140-141 also each include communication interfaces, as well as computer systems, microprocessors, circuitry, or some other processing devices or software systems, and may be distributed among multiple processing devices. Examples of supplemental content providers 140-141 may also each include software such as an operating system, logs, databases, utilities, drivers, networking software, and other software stored on a computer-readable medium. Supplemental content providers 140-141 could also each include application servers, application service provider systems, cloud-based systems, database systems, web servers, streaming media servers, authentication systems, or other systems.

Wireless link 150 uses the air or space as the transport media. Wireless link 150 may use various protocols, such as Code Division Multiple Access (CDMA), Evolution-Data Optimized (EV-DO), single-carrier radio transmission technology link (1xRTT), Worldwide Interoperability for Microwave Access (WIMAX), Global System for Mobile Communication (GSM), Universal Mobile Telecommunications System (UMTS), Long Term Evolution (LTE), Wireless Fidelity (WiFi), High Speed Packet Access (HSPA), Radio Link Protocol (RLP), or some other wireless communication format, including combinations, improvements, or variations thereof. Although one wireless link 150 is shown in FIG. 1, it should be understood that this wireless link is merely illustrative to show communications with wireless communication system 110.

Communication links 151-153 each use metal, glass, optical, air, space, or some other material as the transport media. Communication links 151-153 could each use various communication protocols, such as Time Division Multiplex (TDM), asynchronous transfer mode (ATM), Internet Protocol (IP), Ethernet, synchronous optical networking (SONET), circuit-switched, communication signaling, or some other communication format, including combinations, improvements, or variations thereof. Communication links 151-153 could each be direct links or may include intermediate networks, systems, or devices, such as an Internet network, local area network (LAN), wide area network (WAN), social network, or other computer-based network. Communication links 151-153 may also each comprise optical networks, asynchronous transfer mode (ATM) networks, packet networks, metropolitan-area networks (MAN), or other network topologies, equipment, or systems, including combinations thereof.

Links 150-153 may each include many different signals sharing the same link—as represented by the associated lines in FIG. 1—comprising access channels, paging channels, notification channels, forward links, reverse links, user communications, communication sessions, overhead communications, frequencies, other channels, carriers, timeslots, spreading codes, transportation ports, logical transportation links, network sockets, packets, or communication directions.

FIGS. 1-5 and the previous descriptions depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method of operating a wireless communication system, the method comprising:
receiving a registration request from a wireless communication device, and in response, monitoring device status and updating a data structure with device status data for the wireless communication device;
processing the device status data to determine if a first device status condition is met by the device status data;
if the first device status condition is met by the device status data, selecting a supplemental content provider from a plurality of supplemental content providers based on the first device status condition;
receiving a content request from the wireless communication device for primary content from a primary content provider, and in response, determining an anonymous key associated with the wireless communication device and transferring the anonymous key for delivery to the selected supplemental content provider;
receiving supplemental content transferred by the selected supplemental content provider responsive to the transferred anonymous key;
receiving the primary content transferred by the primary content provider; and
transferring the primary content and the supplemental content to the wireless communication device.

2. The method of claim 1, further comprising:
determining associations between a plurality of device status conditions and the plurality of supplemental content providers, wherein the first device status condition comprises a first one of the plurality of device status conditions determined to be associated with the selected supplemental content provider.

3. The method of claim 2, wherein determining the associations between the plurality of device status conditions and the plurality of supplemental content providers comprises processing ones of the plurality of device status conditions purchased by ones of the plurality of supplemental content providers.

4. The method of claim 1, further comprising:
associating a monetary cost with selecting the selected supplemental content provider from the plurality of supplemental content providers based on the first device status condition.

5. The method of claim 4, further comprising:
transferring an indicator of the monetary cost for delivery to the supplemental content provider.

6. The method of claim 1, further comprising:
in response to the first device status condition being met by the device status data, transferring an indicator of the first device status condition to the selected supplemental content provider.

7. The method of claim 1, further comprising:
transferring the device status data from the data structure for delivery to the selected supplemental content provider.

8. The method of claim 1, wherein the device status data comprises at least one of a present location of the wireless communication device, a present time, an identifier of a wireless access node associated with the wireless communication device, a sector location of the wireless communication device, a velocity of the wireless communication device, a device type of the wireless communication device, and a present RF signal quality associated with the wireless communication device.

9. The method of claim 1, wherein transferring the primary content and the supplemental content to the wireless communication device comprises merging the primary content with the supplemental content to create merged content and transferring the merged content to the wireless communication device.

10. The method of claim 1, further comprising:
receiving the anonymous key with the supplemental content and associating the supplemental content with the wireless communication device based upon the anonymous key.

11. A wireless communication system, comprising:
an access system configured to receive a registration request from a wireless communication device;
a control system configured to, in response the registration request, monitor device status and update a data structure with device status data for the wireless communication device;
the control system configured to process the device status data to determine if a first device status condition is met by the device status data, wherein if the first device status condition is met by the device status data, the control system is configured to select a supplemental content provider from a plurality of supplemental content providers based on the first device status condition;
the access system configured to receive a content request from the wireless communication device for primary content from a primary content provider;
the control system configured to, in response to the content request, determine an anonymous key associated with the wireless communication device and transfer the anonymous key for delivery to the selected supplemental content provider;
the access system configured to receive supplemental content transferred by the selected supplemental content provider responsive to the transferred anonymous key, receive the primary content transferred by the primary content provider, and transfer the primary content and the supplemental content to the wireless communication device.

12. The wireless communication system of claim 11, comprising:
the control system configured to determine associations between a plurality of device status conditions and the plurality of supplemental content providers, wherein the first device status condition comprises a first one of the plurality of device status conditions determined to be associated with the selected supplemental content provider.

13. The wireless communication system of claim 12, wherein the control system is configured to process ones of the plurality of device status conditions purchased by ones of the plurality of supplemental content providers to determine the associations between the plurality of device status conditions and the plurality of supplemental content providers.

14. The wireless communication system of claim 11, comprising:
the control system configured to associate a monetary cost with selecting the selected supplemental content provider from the plurality of supplemental content providers based on the first device status condition.

15. The wireless communication system of claim 14, comprising:
the control system configured to transfer an indicator of the monetary cost for delivery to the supplemental content provider.

16. The wireless communication system of claim 11, comprising:
in response to the device status condition being met by the device status data, the control system configured to transfer an indicator of the first device status condition to the selected supplemental content provider.

17. The wireless communication system of claim 11, comprising:
the control system configured to transfer the device status data from the data structure for delivery to the selected supplemental content provider.

18. The wireless communication system of claim 11, wherein the device status data comprises at least one of a present location of the wireless communication device, a present time, an identifier of a wireless access node associated with the wireless communication device, a sector location of the wireless communication device, a velocity of the wireless communication device, a device type of the wireless communication device, and a present RF signal quality associated with the wireless communication device.

19. The wireless communication system of claim 11, wherein the access system is configured to merge the primary content with the supplemental content to create merged content and transfer the merged content to the wireless communication device to transfer the primary content and the supplemental content to the wireless communication device.

20. The wireless communication system of claim 11, comprising:
the access system configured to receive the anonymous key with the supplemental content and associate the supplemental content with the wireless communication device based upon the anonymous key.
